(19) United States
(12) Patent Application Publication
(10) Pub. No.: US 2010/0177971 A1
(43) Pub. Date: Jul. 15, 2010

(54) Method of Encoding Chinese Type Characters (CJK Characters) Based on Their Structure

(76) Inventor: Gerald Pardoen, Paris (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/352,305

(22) Filed: Jan. 12, 2009

(51) Int. Cl. G06F 9/46

(52) U.S. Cl. 382/232

(57) ABSTRACT

The invention relates to a method of encoding a Chinese type character. The method comprises subdividing the whole said character into N elements in a given order, said order being specific to said character; associating with each of the N elements, in said given order, an elementary descriptor, each of these elementary descriptors being based on the structure of said element with which it is associated; defining a base reference constituted by the elementary descriptors defined at the previous step, these elementary descriptors being placed in said given order. By using this invention, it becomes straightforward to find back a character using its code, to encode, in a logical manner, a new character and add it to the set of characters already encoded, and to classify characters based on their structure. In this way, the “external character problem” is solved.

The present invention relates to a method of encoding Chinese type characters.

### BACKGROUND OF THE INVENTION

By Chinese type character, one refers to characters used in the writing of the Chinese language spoken in China, and to characters of the same origin used (or previously used) in various countries or regions such as mainland China, Japan, South Korea, Vietnam, Taiwan Hong-Kong, Macao, North Korea, Singapore, Malaysia.

Chinese type characters make up a very important set (several tens of thousands) of characters which are all visually different. Furthermore this set is open, which means that new characters may be added into this set. For instance new characters may be created to refer to objects or concepts resulting from technical innovations.

This set is therefore intrinsically different from an alphabet, since in an alphabet the number of letters is low (at most a few tens) and form a closed set (the number is constant).

Considering the special nature of Chinese type characters, the search for a given character among a database containing all these characters, for instance in order to print this character in a file or on paper, or the classification of these characters, raises great difficulties.

For computer-based applications, methods of characters encoding have been developed, such as the Unicode® system, which associates a code with each character. Each code is a string of alphanumeric characters.

Such encoding systems have many flaws. Since a code is randomly assigned to a character, it is not possible to find a character using only its code, without the help of an index. It is also not possible to classify characters based on their structure. It is therefore not possible to digitalize Chinese texts which comprise characters which do not belong to the existing set of coded characters. There is currently a large number of such characters which cannot be found in existing sets. These characters are called “external characters”, and the issue of their absence from the sets is called the “external characters problem”.

Furthermore, when a new character must be added to a set (either a new character corresponding to a technical innovation, or a character which has just been discovered), the new code which is assigned to this new character is necessarily random.

It is also known a method of encoding Chinese type characters, called the “Geo-stroke method”, disclosed in U.S. Pat. No. 5,790,055 to Yu.

Each character is identified by an eight-digit code, comprised of a four-digit FRAME code and a four-digit ID code. A digit is associated to each of the four corners of the character, based on the shape of each of these corners, thus yielding the FRAME code. Then one of the blocks making up the character is selected based on a set of rules. A digit is then associated with each of the four corners of this block, based on the shape of each of these corners (following the known “four-corners” method), thus yielding the ID code. In case of duplication of the eight-digit code between two distinct characters, a 9^{th} digit representative of the number of certain strokes in the selected block is added, and if necessary a 10^{th} digit representative of the total number of blocks making up the character is added.

However the “Geo-stroke method” is unable to give the full structure of the character, because it does not encode all the blocks making up the character. The “Geo-stroke method” does not allow a classification of characters based on their structure. Furthermore, several distinct shapes of the corners are associated to the same digit, which hinders the reconstruction of the character from the code.

Consequently characters differing only by their non-selected blocks cannot be distinguished from each other, and therefore the external character problem cannot be solved.

The present invention seeks to remedy these drawbacks.

### OBJECTS AND SUMMARY OF THE INVENTION

An object of the invention is to provide a method of encoding Chinese type characters which is based on their structure.

This object is achieved by the fact that the method comprises the following steps:
(a) Subdividing the said character into N elements in a given order, said order being specific to said character;
(b) Associating with each of the N elements, in said given order, an elementary descriptor, each of these elementary descriptors being based on the structure of said element with which it is associated;
(c) Defining a base reference constituted by the elementary descriptors defined at step (b), these elementary descriptors being placed in said given order.

Another object of the invention is to provide a method of classifying characters based on their structure, which furthermore allows the addition of new characters into the set of already coded characters in a logical way.

This object is achieved by the fact that the method comprises the following steps:
(a) Checking whether a character of the set is orthodox;
(b) If said character is not orthodox, replacing said character with an orthodox form of said character;
(c) Subdividing this orthodox form of said character into 4 elements in the order in which the strokes constituting the orthodox form of said character are drawn, each of the said elements which contains a stroke being constituted by an elementary block, possibly repeated inside said element, said elementary block being chosen in a finite list of characters;
(d) Associating with each of the 4 elements, in said order, an elementary descriptor, each of these elementary descriptors being constituted by a repetition index which is representative of the number of times said elementary block appears in said element, and by a base component which is associated with said elementary block, and which is based on the structure of said elementary block;
(e) Defining a base reference constituted by the elementary descriptors defined at step (d), these elementary descriptors being placed in said order;
(f) Repeating steps (b) to (e) for each other orthodox form of said character in case said character has more than one orthodox form;
(g) Repeating steps (a) to (f) for each character in said set;
(h) For each orthodox character of said set, grouping together all the characters of said set having the same base reference as said each orthodox character, thereby defining the family of said each orthodox character;
(i) For each family defined in step (h), assigning to each character of said family an indicator which distinguishes this character from other characters of the same family;
(j) Assigning to said character a structural reference, constituted by said indicator and said base reference.

By means of these provisions, a code which fully encompasses the structure of any given character can be associated to this character.

Using the method of the invention, it becomes then straightforward to find back a character using its code. Using the method of the invention, it is also possible to encode, in a logical manner, a new character (either a new character corresponding to a technical innovation, or a character which has just been discovered) and add it to the set of characters already encoded.

It becomes therefore easy to classify characters based on their structure, such as grouping in a sub-set all characters having a given elementary block in common.

### BRIEF DESCRIPTION OF THE DRAWINGS

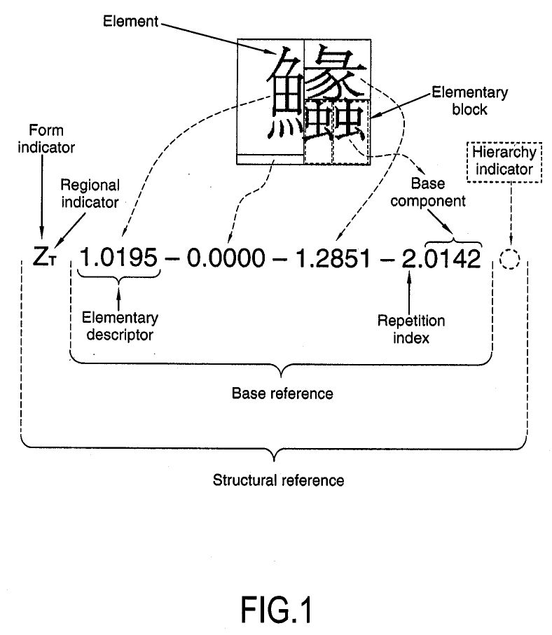

The invention can be better understood and its advantages appear more clearly on reading the following detailed description of an implementation given by way of non-limiting example. The description refers to the accompanying drawing, in which FIG. 1 shows the encoding method according to the invention, applied to a Chinese type character.

### MORE DETAILED DESCRIPTION

Chinese type characters are constituted by strokes. These strokes are written in a given order. The order in which the strokes are written follows seven rules which are well-known to any student of Chinese, and are invariable. These rules are as follows, each or several being applied depending on which character is being written:

Rule 1: horizontal strokes then vertical strokes

Rule 2: down leftward strokes then down rightward strokes

Rule 3: from top strokes to bottom strokes

Rule 4: outside strokes then inside strokes

Rule 5: from left side strokes to right side strokes

Rule 6: bottom stroke of the door last

Rule 7: from middle stroke to left side strokes to right side strokes

By following these rules, the strokes constituting any given character can only be written in a certain order, therefore there is only one way to write a given character. Below are examples of the stroke order in which characters are written, and the corresponding rule used:

Rule 1:

[symbol]

Rule 2:

[symbol]

Rule 3:

[symbol]

Rule 4:

[symbol]

Rule 5:

[symbol]

Rule 6:

[symbol]

Rule 7:

[symbol]

In each character, the strokes form one or more groups, so that any character is constituted by one or more groups of strokes, each group possibly being in itself a known Chinese type character. All known characters are actually made up of a small number N (positive integer) of groups of strokes: a given character would most often have less than 10 groups of strokes. The inventor has found out, through extensive studies, that the total number of such groups of strokes which make up all known character is a finite number (a few thousands) which is several orders of magnitude smaller than the number of known Chinese type characters.

All these groups of strokes form a set of characters, which can therefore be used to build all known characters.

A group of strokes which belong to this set is called an elementary block.

Consequently, by associating a different elementary descriptor, such as a string of alphanumeric characters, to each elementary block constituting a Chinese character, each Chinese type character can be uniquely identified by a series of elementary descriptors put together. These elementary descriptors are placed in the order in which the elementary blocks are written inside the character, so that two characters constituted of the same elementary blocks but whose position inside the character is permuted can be distinguished. The elementary descriptors placed as such make up a base reference, which can for instance be a string of digits. The base reference for a given character is therefore directly based upon the structure of this character.

Alternatively, the elementary descriptors could be arranged in a different order, such as the reverse reading order of the elementary blocks.

As a result, the base reference can be used to find a character in a set of characters. More interestingly, all characters containing a given elementary block can be easily found by looking, among all the base references, for the ones containing the elementary descriptor corresponding to that elementary block. Furthermore, when one needs to add a new character, this character can be straightforwardly assigned a base reference using the above method, and this base reference will be directly representative of the structure of this new character. Consequently, new characters can be added to the group of known characters in a logical way.

An embodiment of the invention is described below.

According to the invention, each Chinese type character is first analyzed to see if it is an orthodox form character or another form of character. Orthodoxy of a Chinese type character is a well-known concept, and the orthodox or non-orthodox nature of a character can be readily identified by any student of Chinese in the existing literature. Each character is either orthodox or has at least one orthodox equivalent. If the character is not orthodox, then it is replaced by one of its orthodox equivalents.

Through extensive studies, the inventor has compiled a special set of elementary blocks which is such that that all known orthodox characters can be built from this set using at most four distinct elementary blocks from this set (an elementary block can possibly be repeated inside the orthodox character, as explained below). The inventor has found out that this special set contains about 1500 elementary blocks. Consequently N is always equal to 4 in the embodiment now described.

All these elementary blocks in their orthodox form and the corresponding base component of each are listed in Table 4 and Table 5 (see at the end of the specification).

Any orthodox character can therefore be subdivided into 4 elements, each element being either made up of one elementary block, or of one elementary block repeated several times, or being empty (that is containing no strokes).

The subdivision method of an orthodox character is as follows: to begin with, all the elementary blocks in a character are identified. These elementary blocks are chosen in this special set. If an elementary block is repeated (twice or more) inside a character, then this group made up of identical elementary blocks is considered as one single element. Otherwise each elementary block (not repeated inside the character) makes up one element. Then the total number of elements inside the character is counted.

If the total number of counted elements is equal to 4, then each element contains at least one elementary block, and the character is made up of 4 elements.

As pointed out above, the special set of elementary blocks is such that it is always possible to build any orthodox character with at most 4 distinct elementary blocks from this special set. When choosing how the orthodox character should be divided into elementary blocks, the elementary blocks appearing in the orthodox character and which have the highest number of strokes should be selected in order for the orthodox character to be made up of at most 4 elementary blocks.

If the total number of counted elements is 1, 2, or 3, then 3, 2, or 1 element(s) respectively contain(s) no strokes and will be empty. These empty elements are added to the number of counted elements, so that the character is constituted exactly by 4 elements.

With each of the 4 elements making up a character, it is associated a different elementary descriptor. Each elementary descriptor is constituted by a repetition index which is representative of the number of times an elementary block appears in the element, and by a base component which is associated with the elementary block. For instance, the repetition index is a digit equal to the number of times the elementary block appears in the element, and the base component is a four-digit number (since there are less than 10,000 elementary blocks). The elementary descriptor contains therefore 5 digits.

The four-digit number of the base component can be assigned to an elementary block randomly. For the sake of convenience, if the elementary block is one of the 214 radicals of the known Kangxi dictionary which are listed in Table 5, then the first digit of the base component associated with said elementary block is 0. The radical is a well-known concept; it is the part of the character which gives an indication about the meaning of the character. For any given character comprising a radical, the radical is readily identified by any student of Chinese. Also, if the elementary block is not one the 214 radicals of the Kangxi dictionary then the first digit of the base component associated with this elementary block is 1 or more and the number P constituted by the first two digits of the base component is determined by the number T of strokes in the elementary block to which the base component is associated.

Table 4 and Table 5 give an example of how a base component can be associated to each elementary block of the special set from which all known orthodox characters can be built using the above scheme. This is merely an example, and a different base component could be assigned to each elementary block.

A repetition index equal to 0 and a base component equal to 0000 are associated with an element which does not contain any stroke (empty element). The elementary descriptor associated with an empty element is written 0.0000 and is called a null elementary descriptor.

To each element, it is therefore assigned an elementary descriptor containing 5 digits. The base reference contains therefore 4 groups of 5 digits, that is 20 digits. These 4 groups are placed together (that is written one after the other, from left to right) depending on the order in which the character is written using the invariable rules given herein.

A special situation arises when one or more of the elements making up the orthodox character is empty. The null elementary descriptor, which corresponds to this empty element, could then be placed before or after an adjacent element containing strokes.

It is possible to devise a set of rules which govern the position of this empty element within the base reference.

An example of such rules is given in Table 1 below.

These rules make use of the fact that each orthodox character contains an element which is a radical or which can act as a radical.

TABLE 1

| N^{o} | Structure | Substructure | Base descriptor |
|---|---|---|---|
| 1 | □ | □ | R.RRRR-0.0000-0.0000-0.0000 |
| 2 | □ | □ | 0.0000-0.0000-0.0000-N.NNNN |
| 3 | [symbol] | [symbol] | R.RRRR-0.0000-0.0000-N.NNNN |
| 4 | [symbol] | [symbol] | 0.0000-0.0000-N.NNNN-R.RRRR |
| 5 | [symbol] | [symbol] | R.RRRR-0.0000-N.NNNN-N.NNNN |
| 6 | [symbol] | [symbol] | N.NNNN-N.NNNN-0.0000-R.RRRR |
| 7 | [symbol] | [symbol] | 0.0000-N.NNNN-N.NNNN-N.NNNN |
| 8 | [symbol] | [symbol] | 0.0000-R.RRRR-0.0000-N.NNNN |
| 9 | [symbol] | [symbol] | 0.0000-N.NNNN-0.0000-R.RRRR |
| 10 | [symbol] | [symbol] | R.RRRR-0.0000-N.NNNN-N.NNNN |
| 11 | [symbol] | [symbol] | N.NNNN-N.NNNN-0.0000-R.RRRR |
| 12 | [symbol] | [symbol] | 0.0000-N.NNNN-N.NNNN-N.NNNN |
| 13 | [symbol] | [symbol] | R.RRRR-0.0000-0.0000-N.NNNN |
| 14 | [symbol] | [symbol] | R.RRRR-0.0000-N.NNNN-N.NNNN |
| 15 | [symbol] | [symbol] | 0.0000-R.RRRR-0.0000-N.NNNN |
| 16 | [symbol] | [symbol] | 0.0000-N.NNNN-0.0000-R.RRRR |
| 17 | [symbol] | [symbol] | R.RRRR-0.0000-0.0000-N.NNNN |
| 18 | [symbol] | [symbol] | R.RRRR-0.0000-N.NNNN-N.NNNN |
| 19 | [symbol] | [symbol] | R.RRRR-0.0000-0.0000-N.NNNN |
| 20 | [symbol] | [symbol] | R.RRRR-0.0000-N.NNNN-N.NNNN |
| 21 | [symbol] | [symbol] | 0.0000-R.RRRR-0.0000-N.NNNN |
| 22 | [symbol] | [symbol] | 0.0000-0.0000-N.NNNN-N.NNNN |
| 23 | [symbol] | [symbol] | 0.0000-R.RRRR-0.0000-N.NNNN |
| 24 | [symbol] | [symbol] | 0.0000-N.NNNN-0.0000-0.0000 |
| 25 | [symbol] | [symbol] | 0.0000-0.0000-N.NNNN-0.0000 |

Table 1 lists the global structure of a character, the substructure of a character, and the corresponding base descriptor where the radical (as listed in Table 5) is indicated by the letter “R”, and the other elements which make up a character are indicated by the letter “N” (these other elements can belong to Table 4 or Table 5).

Depending on the position of the radical within the character, the global structure of the character is determined. For a given global structure, various sub-structures of the character are possible depending on the position within the character of elements other than the radical.

In Table 1, by looking at case 3 (row 3) which corresponds to a character made up of two elements side by side with the radical on the left, and at case 4 (row 4) which corresponds to a character made up of two elements side by side with the radical on the right, one can see that the two null elementary descriptor, which correspond to each of the two empty elements of the character, are at different positions in the base reference.

Consequently, by using the rules set out in Table 1 above and looking at the position of the null elementary descriptor(s) in the base reference, one can also instantly know, in an orthodox character, the position of a radical or of the element acting as a radical.

Furthermore, the above method can be used to find, among orthodox characters, all characters having the same radical, or all characters having the same radical at the same position. This is very useful for classifying characters.

Rules other than the ones of table 1 could also be used to position the null elementary descriptors within the base reference.

As an example, FIG. 1 shows how a character, [symbol] is subdivided as explained above. This character is an orthodox character. An imaginary square, overlapping the character, is divided into 4 smaller rectangles, a top-left rectangle, a bottom-left rectangle, a top-right rectangle, and a bottom-right rectangle, as shown in FIG. 1. Each rectangle covers an element, and is empty if the element is empty. The present character is read from left to right (rule 5), then from top to bottom (rule 3). In reading order, the 1^{st} element, inside the top-left rectangle, contains the elementary block [symbol] The 2^{nd} element, inside the bottom-left rectangle, is empty. The 3^{rd} element, inside the top-right rectangle, contains the elementary block [symbol] The 4^{th} element, inside the bottom-right rectangle, contains the character [symbol] The 1^{st} and 3^{rd} elements are made up of a single elementary block. The 4^{th} element is made up of the elementary block [symbol] repeated twice.

Based on Table 1, it is seen that the empty element is indeed in 2^{nd} position, since the character corresponds to case 5 (row 5).

The 1^{st} elementary descriptor, associated with the 1^{st} element, is 1.0195. The first digit is the repetition index. It is equal to 1, since the elementary block appears once in the 1^{st} element. A dot “.” separates the repetition index from the base component, for easier readability. The base component of the elementary block in the 1^{st} element is 0195, based on Table 5 (since this elementary block is a Kangxi radical, with a base component starting with zero).

The 2^{nd} elementary descriptor is 0.0000 (null elementary descriptor), since the 2^{nd} element is empty.

The 3^{rd} elementary descriptor is 1.2851, since the elementary block in the 3^{rd} element appears only once, and its base component is 2851, based on Table 4 (this elementary block is not a Kangxi radical).

The 4^{th} elementary descriptor is 2.0142, since the elementary block in the 3^{rd} element appears twice, and its base component is 0142, based on Table 5 (since this elementary block is a Kangxi radical, with a base component starting with zero).

Therefore, the base reference for the character is made up of the 1^{st}, 2^{nd}, 3^{rd}, and 4^{th} elementary descriptors, written in that order, as follows (see FIG. 1):
1.0195-0.0000-1.2851-2.0142

For reasons of readability, the 4 elementary descriptors are separated from each other by an hyphen “-”. Alternatively, they could be separated by another sign, or not be separated.

The above example illustrates the fact that each base reference is associated with a unique orthodox character.

Next the concept of character family is explained.

The majority of Chinese characters are not orthodox characters. We have seen that each non-orthodox character has at least one orthodox equivalent, that is an orthodox character. A non-orthodox character is in fact a variation of at least one orthodox character. Each of the orthodox equivalents to a non-orthodox character can be found in the existing literature (such as dictionaries).

In order to encode a non-orthodox character, this character is assigned some indicator. For instance, it is assigned a form indicator, possibly a hierarchy indicator, and a regional indicator.

The form indicator indicates the form of the non-orthodox character. This form can be orthodox, can be a variant form of an orthodox character, an erroneous form of a character, a classical form of a character, a simplified form of a character, an alternative form of a character, a prohibited form of a character, a radical form of a character, or a strokes form of a character. A student of Chinese can readily identify, using the existing literature, which form among the above 8 forms is the form of a non-orthodox character. There are further possible forms beyond the above ones, such as: oracle bone form, bronze form, large seal form, small seal form, clerical form, running form, grass form (cursive script).

Table 2 below gives an example of how a different alphanumeric character (in the present case a different letter), can be assigned to each form. This letter is the form indicator.

TABLE 2

| | Classical Chinese | Simplified Chinese | |
|---|---|---|---|
| Form of the character | name of the form | name of the form | Letter |
| Orthodox form | [symbol] | [symbol] | Z |
| Variant form | [symbol] | [symbol] | Y |
| Erroneous form | [symbol] | [symbol] | E |
| Classical form | [symbol] | [symbol] | F |
| Simplified form | [symbol] | [symbol] | J |
| Alternative form | [symbol] | [symbol] | A |
| Prohibited form | [symbol] | [symbol] | P |
| Radical form | [symbol] | [symbol] | R |
| Strokes form | [symbol] | [symbol] | S |
| Oracle bone form | [symbol] | [symbol] | G |
| Bronze form | [symbol] | [symbol] | N |
| Large seal form | [symbol] | [symbol] | D |
| Small seal form | [symbol] | [symbol] | X |
| Clerical form | [symbol] | [symbol] | L |
| Running form | [symbol] | [symbol] | I |
| Grass form | [symbol] | [symbol] | C |

If needed, more forms could be added to this list, and a different letter assigned to each.

A non-orthodox character may have many variations. When several (already known) non-orthodox characters have the same form indicator and base reference, then a non-orthodox character is differentiated from another by adding to its base reference and form indicator an additional indicator, called a hierarchy indicator. The hierarchy indicator is for instance assigned by increasing order of the radical according to the order given in the Kangxi dictionary and by increasing number of strokes after the radical.

For instance the character [symbol] and the character [symbol] have:
the same form indicator (Y, see Table 2) and,
the same base reference (1.0195-0.0000-1.2851-2.0142).

In order to differentiate one character from the other, a hierarchy indicator is added to the form indicator and base reference of each of these characters (see below).

The hierarchy indicator can for instance be a number starting from 1, and which is incremented to differentiate a character from another.

In case an orthodox character has only one non-orthodox character with the same form indicator and base reference, it is not necessary to assign a hierarchy indicator to this non-orthodox character. However, if it is likely that there exists another non-orthodox character with the same form indicator and base reference, then the non-orthodox character can be assigned a hierarchy indicator of 1.

A character is also assigned a regional indicator. The regional indicator indicates the current geographical origin of a character. This region of origin can be mainland China, Japan, South Korea, Vietnam, Taiwan, Hong-Kong, Macao, North Korea, Singapore, and Malaysia. The origin of the text to which the character belongs, or the environment from which the character comes, can give the current origin of the character.

Table 3 below gives an example of how a different letter can be assigned to each geographical origin of the above list. Alternatively, a division defining another set of geographical origins could be used (such as a division based on the various provinces of a country), and a different letter assigned to each.

TABLE 3

| Country | Letter | Country | Letter |
|---|---|---|---|
| China | C | Hong-Kong | H |
| Japan | J | Macao | A |
| South Korea | K | North Korea | N |
| Vietnam | V | Singapore | S |
| Taiwan | T | Malaysia | M |

To each character, orthodox or non-orthodox, can now be assigned at least one code, called a structural reference, constituted by a form indicator, a base reference, possibly a hierarchy indicator, and a regional indicator). All the characters which have the same base reference belong to the same family (of an orthodox character).

Some non-orthodox characters have several orthodox equivalents. Therefore they have several structural references, and thus belong to several families.

Furthermore, some characters which are already orthodox can belong to one or more families other than their own.

According to Table 2, an orthodox character is assigned the form indicator Z. The orthodox character [symbol] which we studied above, may be found in a text from Taiwan, so it is assigned the regional indicator T based on Table 3. For readability sake, the regional indicator is written as a subscript of the form indicator. As indicated in FIG. 1, the structural reference of this orthodox character is:
Z_{T} 1.0195-0.0000-1.2851-2.0142

As an example in Taiwan, the character, [symbol] which is a variant form of the orthodox character [symbol] has therefore a structural reference:
Y_{T} 1.0195-0.0000-1.2851-2.0142 \textcircled{1}

It has the hierarchy indicator \textcircled{1} because it it's the first graphical variant of [symbol] It belongs to the family of the orthodox character

[symbol]

The method consisting in assigning to each character a structural reference constituted by a form indicator, a base reference, possibly a hierarchy indicator, and a regional indicator, is a powerful method of classifying Chinese type characters. Indeed, it becomes easy to find a non-orthodox character, which is a graphical variation of an orthodox character, merely by looking into the family of this orthodox character.

For instance, the two above characters belong to the family with the base reference 1.0195-0.0000-1.2851-2.0142. This family comprises, among others, the four following characters:
An orthodox character [symbol] which has the structural reference:
Z_{T} 1.0195-0.0000-1.2851-2.0142
A first graphical variant [symbol] which has the structural reference:
Y_{T} 1.0195-0.0000-1.2851-2.0142 \textcircled{1}
A second graphical variant [symbol] which has the structural reference:
Y_{T} 1.0195-0.0000-1.2851-2.0142 \textcircled{2}
A third graphical variant [symbol] which has the structural reference:
Y_{T} 1.0195-0.0000-1.2851-2.0142 \textcircled{3}

Furthermore a new character (that is newly discovered or created) which is known to belong to a given already existing family, can be added in a logical way to the current set of characters. If this new character has the same form indicator and base reference as one or several characters already belonging to this given family, then this new character is merely given a hierarchy indicator. This hierarchy indicator is obtained, for instance, by incrementing the highest existing hierarchy indicator of the character of this family with the same form indicator and base reference.

Next the concepts of “connexion” and “main structural reference” are explained.

If a Chinese type character belongs to several distinct families, then it is said to have several connexions, and to each of these connexions corresponds a distinct structural reference.

The concept of “connexion” for a character is somewhat similar to the concept of “meaning” for a word in English, in that a word (for instance “shell”) may have different meanings (“carapace” (of a sea animal), or “bomb” (as used in ordnance)).

Indeed, Chinese type characters have evolved over several thousand years, and many times a first character has evolved into a second character which ends up being identical to a third existing character. One character may thus have several histories or path of evolution.

For instance the character [symbol] has a first connexion with the structural reference
Z_{T} 1.0195-0.0000-1.2851-2.0142
   because it is the orthodox character used in Taiwan of the family which has the base reference 1.0195-0.0000-1.2851-2.0142 (as seen above).
   The character [symbol] also has a second connexion with the structural reference
Y_{T} 1.0195-0.0000-0.000-1.3622 \textcircled{5}
   because this character is also the fifth (\textcircled{5}) variant form (Y) used in Taiwan of the orthodox character [symbol] of the family which has the base reference 1.0 195-0.0000-0.000-1.3622.

Thus we see that the character [symbol] belongs to two different families (its own family, and the family of the orthodox character

[symbol]

In some cases a character belongs to only one family, however this character may also have several connexions. Indeed, in mainland China, characters have been more recently simplified into a simplified form. In many occurrences the simplified form of a character of a family is also, at the origin, a variant form of the orthodox character of this family. As a result, a same character can have two or more connexions in the same family, and so be assigned two or more different structural references.

For instance, the character [symbol] has a first connexion with the structural reference
Y_{T} 1.0205-0.0000-0.0000-0.0000 0
   because this character is the second (\textcircled{2}) variant form (Y) used in Taiwan of the orthodox character [symbol] of the family which has the base reference 1.0205-0.0000-0.0000-0.0000 (see Table 3).

The character [symbol] also has a second connexion in the same family with the structural reference
J_{c} 1.0205-0.0000-0.0000-0.0000
   because it is (since 1964) the simplified form (J) used in mainland China of the same orthodox character (see Table 3).

The character [symbol] has then two connexions and therefore two structural references: its first connexion is the second variant form of a first character, and its second connexion is the simplified form of a second identical character

[symbol]

We have seen that a character may have different connexions, and therefore be assigned different structural references. Among these structural references, one is the “main structural reference” of the character, so that to each character always corresponds a unique “main structural reference”.

The “main structural reference” is determined as follows:
If a character has only one structural reference, then its “main structural reference” is this structural reference.
If a character has several structural references, one of which being an orthodox form, then the “main structural reference” is this orthodox form.
If a character has several structural references, none of which being an orthodox form, then the “main structural reference” is the structural reference with the smallest hierarchy indicator, and if two or more of these structural references have the smallest hierarchy indicator, then the main structural reference is the one among these two or more structural references which has the smallest non-zero base component.

Of course, other schemes than the one herein described could be used to determine the “main structural reference”.

Many characters have several connexions. Using the concept of “connexion” allows conversion of a text written in Chinese type characters into another version of that text. By another version of an original text, it is meant a text where, starting from the original text, each character has been converted into another variation of this character. This other variation of a character can be for instance a form of that character used in another country, or a traditional form of the character.

Thus, in order to convert a text written in traditional Chinese used in Hong-Kong into simplified Chinese used in mainland China, one can find, for each character, its simplified form among its various connexions.

The methods of encoding of the invention can be transformed into a computer software. This software could then be implemented in many ways, such as for instance: use of the software as in IME (Input Method Editor), use of the software as a character encoding layer between operative systems and font sets, use of the software as a support tool to create new standards.

An advantage of the invention is that all the Chinese type characters can be encoded using digits (0-9) and alphabetical letters (A-Z), without a need for using special alphanumeric characters. In this way, the user can manipulate a set of Chinese type characters and a text written with these characters more efficiently and quickly.

Table 4 and Table 5, mentioned above, are given below.

TABLE 4
1 STROKE

| | | | | | | | | | |
|---|---|---|---|---|---|---|---|---|---|
| 1201 | [symbol] | 1202 | [symbol] | 1203 | [symbol] | 1204 | [symbol] | 1205 | [symbol] |
| 1206 | [symbol] | 1207 | [symbol] | 1208 | [symbol] | 1209 | [symbol] | 1210 | [symbol] |
| 1211 | [symbol] | 1212 | [symbol] | 1213 | [symbol] | 1214 | [symbol] | 1215 | [symbol] |
| 1216 | [symbol] | 1217 | [symbol] | 1218 | [symbol] | 1219 | [symbol] | 1220 | [symbol] |
| 1221 | [symbol] | 1222 | [symbol] | 1223 | [symbol] | 1224 | [symbol] | 1225 | [symbol] |
| 1226 | [symbol] | 1227 | [symbol] | 1228 | [symbol] | 1229 | [symbol] | 1230 | [symbol] |
| 1231 | [symbol] | 1232 | [symbol] | 1233 | [symbol] | 1234 | [symbol] | 1235 | [symbol] |

2 STROKES

| | | | | | | | | | |
|---|---|---|---|---|---|---|---|---|---|
| 1401 | [symbol] | 1402 | [symbol] | 1403 | [symbol] | 1404 | [symbol] | 1405 | [symbol] |
| 1406 | [symbol] | 1407 | [symbol] | 1408 | [symbol] | 1409 | [symbol] | 1410 | [symbol] |
| 1411 | [symbol] | 1412 | [symbol] | 1413 | [symbol] | 1414 | [symbol] | 1415 | [symbol] |

3 STROKES

| | | | | | | | | | |
|---|---|---|---|---|---|---|---|---|---|
| 1601 | [symbol] | 1602 | [symbol] | 1603 | [symbol] | 1604 | [symbol] | 1605 | [symbol] |
| 1606 | [symbol] | 1607 | [symbol] | 1608 | [symbol] | 1609 | [symbol] | 1610 | [symbol] |
| 1611 | [symbol] | 1612 | [symbol] | 1613 | [symbol] | 1614 | [symbol] | 1615 | [symbol] |
| 1616 | [symbol] | 1617 | [symbol] | 1618 | [symbol] | 1619 | [symbol] | 1620 | [symbol] |
| 1621 | [symbol] | 1622 | [symbol] | 1623 | [symbol] | 1624 | [symbol] | 1625 | [symbol] |
| 1626 | [symbol] | 1627 | [symbol] | 1628 | [symbol] | 1629 | [symbol] | 1630 | [symbol] |
| 1631 | [symbol] | 1632 | [symbol] | 1633 | [symbol] | 1634 | [symbol] | | |

4 STROKES

| | | | | | | | | | |
|---|---|---|---|---|---|---|---|---|---|
| 1801 | [symbol] | 1802 | [symbol] | 1803 | [symbol] | 1804 | [symbol] | 1805 | [symbol] |
| 1806 | [symbol] | 1807 | [symbol] | 1808 | [symbol] | 1809 | [symbol] | 1810 | [symbol] |
| 1811 | [symbol] | 1812 | [symbol] | 1813 | [symbol] | 1814 | [symbol] | 1815 | [symbol] |
| 1816 | [symbol] | 1817 | [symbol] | 1818 | [symbol] | 1819 | [symbol] | 1820 | [symbol] |
| 1821 | [symbol] | 1822 | [symbol] | 1823 | [symbol] | 1824 | [symbol] | 1825 | [symbol] |
| 1826 | [symbol] | 1827 | [symbol] | 1828 | [symbol] | 1829 | [symbol] | 1830 | [symbol] |
| 1831 | [symbol] | 1832 | [symbol] | 1833 | [symbol] | 1834 | [symbol] | 1835 | [symbol] |
| 1836 | [symbol] | 1837 | [symbol] | 1838 | [symbol] | 1839 | [symbol] | 1840 | [symbol] |
| 1841 | [symbol] | 1842 | [symbol] | 1843 | [symbol] | 1844 | [symbol] | 1845 | [symbol] |
| 1846 | [symbol] | 1847 | [symbol] | 1848 | [symbol] | 1849 | [symbol] | 1850 | [symbol] |
| 1851 | [symbol] | 1852 | [symbol] | 1853 | [symbol] | 1854 | [symbol] | 1855 | [symbol] |
| 1856 | [symbol] | 1857 | [symbol] | 1858 | [symbol] | 1859 | [symbol] | 1860 | [symbol] |
| 1861 | [symbol] | 1862 | [symbol] | 1863 | [symbol] | 1864 | [symbol] | 1865 | [symbol] |
| 1866 | [symbol] | 1867 | [symbol] | 1868 | [symbol] | 1869 | [symbol] | 1870 | [symbol] |
| 1871 | [symbol] | 1872 | [symbol] | 1873 | [symbol] | 1874 | [symbol] | 1875 | [symbol] |
| 1876 | [symbol] | 1877 | [symbol] | 1878 | [symbol] | 1879 | [symbol] | 1880 | [symbol] |
| 1881 | [symbol] | 1882 | [symbol] | 1883 | [symbol] | 1884 | [symbol] | 1885 | [symbol] |
| 1886 | [symbol] | | | | | | | | |

5 STROKES

| | | | | | | | | | |
|---|---|---|---|---|---|---|---|---|---|
| 2001 | [symbol] | 2002 | [symbol] | 2003 | [symbol] | 2004 | [symbol] | 2005 | [symbol] |
| 2006 | [symbol] | 2007 | [symbol] | 2008 | [symbol] | 2009 | [symbol] | 2010 | [symbol] |
| 2011 | [symbol] | 2012 | [symbol] | 2013 | [symbol] | 2014 | [symbol] | 2015 | [symbol] |
| 2016 | [symbol] | 2017 | [symbol] | 2018 | [symbol] | 2019 | [symbol] | 2020 | [symbol] |
| 2021 | [symbol] | 2022 | [symbol] | 2023 | [symbol] | 2024 | [symbol] | 2025 | [symbol] |
| 2026 | [symbol] | 2027 | [symbol] | 2028 | [symbol] | 2029 | [symbol] | 2030 | [symbol] |
| 2031 | [symbol] | 2032 | [symbol] | 2033 | [symbol] | 2034 | [symbol] | 2035 | [symbol] |
| 2036 | [symbol] | 2037 | [symbol] | 2038 | [symbol] | 2039 | [symbol] | 2040 | [symbol] |
| 2041 | [symbol] | 2042 | [symbol] | 2043 | [symbol] | 2044 | [symbol] | 2045 | [symbol] |
| 2046 | [symbol] | 2047 | [symbol] | 2048 | [symbol] | 2049 | [symbol] | 2050 | [symbol] |
| 2051 | [symbol] | 2052 | [symbol] | 2053 | [symbol] | 2054 | [symbol] | 2055 | [symbol] |
| 2056 | [symbol] | 2057 | [symbol] | 2058 | [symbol] | 2059 | [symbol] | 2060 | [symbol] |
| 2061 | [symbol] | 2062 | [symbol] | 2063 | [symbol] | 2064 | [symbol] | 2065 | [symbol] |
| 2066 | [symbol] | 2067 | [symbol] | 2068 | [symbol] | 2069 | [symbol] | 2070 | [symbol] |
| 2071 | [symbol] | 2072 | [symbol] | 2073 | [symbol] | 2074 | [symbol] | 2075 | [symbol] |
| 2076 | [symbol] | 2077 | [symbol] | 2078 | [symbol] | 2079 | [symbol] | 2080 | [symbol] |
| 2081 | [symbol] | 2082 | [symbol] | 2083 | [symbol] | 2084 | [symbol] | 2085 | [symbol] |
| 2086 | [symbol] | 2087 | [symbol] | 2088 | [symbol] | 2089 | [symbol] | 2090 | [symbol] |
| 2091 | [symbol] | 2092 | [symbol] | 2093 | [symbol] | 2094 | [symbol] | 2095 | [symbol] |
| 2096 | [symbol] | 2097 | [symbol] | 2098 | [symbol] | 2099 | [symbol] | 2100 | [symbol] |
| 2101 | [symbol] | 2102 | [symbol] | 2103 | [symbol] | 2104 | [symbol] | 2105 | [symbol] |
| 2106 | [symbol] | 2107 | [symbol] | | | | | | |

6 STROKES

| | | | | | | | | | |
|---|---|---|---|---|---|---|---|---|---|
| 2201 | [symbol] | 2202 | [symbol] | 2203 | [symbol] | 2204 | [symbol] | 2205 | [symbol] |
| 2206 | [symbol] | 2207 | [symbol] | 2208 | [symbol] | 2209 | [symbol] | 2210 | [symbol] |
| 2211 | [symbol] | 2212 | [symbol] | 2213 | [symbol] | 2214 | [symbol] | 2215 | [symbol] |
| 2216 | [symbol] | 2217 | [symbol] | 2218 | [symbol] | 2219 | [symbol] | 2220 | [symbol] |
| 2221 | [symbol] | 2222 | [symbol] | 2223 | [symbol] | 2224 | [symbol] | 2225 | [symbol] |
| 2226 | [symbol] | 2227 | [symbol] | 2228 | [symbol] | 2229 | [symbol] | 2230 | [symbol] |
| 2231 | [symbol] | 2232 | [symbol] | 2233 | [symbol] | 2234 | [symbol] | 2235 | [symbol] |
| 2236 | [symbol] | 2237 | [symbol] | 2238 | [symbol] | 2239 | [symbol] | 2240 | [symbol] |
| 2241 | [symbol] | 2242 | [symbol] | 2243 | [symbol] | 2244 | [symbol] | 2245 | [symbol] |
| 2246 | [symbol] | 2247 | [symbol] | 2248 | [symbol] | 2249 | [symbol] | 2250 | [symbol] |
| 2251 | [symbol] | 2252 | [symbol] | 2253 | [symbol] | 2254 | [symbol] | 2255 | [symbol] |
| 2256 | [symbol] | 2257 | [symbol] | 2258 | [symbol] | 2259 | [symbol] | 2260 | [symbol] |
| 2261 | [symbol] | 2262 | [symbol] | 2263 | [symbol] | 2264 | [symbol] | 2265 | [symbol] |
| 2266 | [symbol] | 2267 | [symbol] | 2268 | [symbol] | 2269 | [symbol] | 2270 | [symbol] |
| 2271 | [symbol] | 2272 | [symbol] | 2273 | [symbol] | 2274 | [symbol] | 2275 | [symbol] |
| 2276 | [symbol] | 2277 | [symbol] | 2278 | [symbol] | 2279 | [symbol] | 2280 | [symbol] |
| 2281 | [symbol] | 2282 | [symbol] | 2283 | [symbol] | 2284 | [symbol] | 2285 | [symbol] |
| 2286 | [symbol] | 2287 | [symbol] | 2288 | [symbol] | 2289 | [symbol] | 2290 | [symbol] |
| 2291 | [symbol] | 2292 | [symbol] | 2293 | [symbol] | 2294 | [symbol] | 2295 | [symbol] |
| 2296 | [symbol] | 2297 | [symbol] | 2298 | [symbol] | | | | |

7 STROKES

| | | | | | | | | | |
|---|---|---|---|---|---|---|---|---|---|
| 2401 | [symbol] | 2402 | [symbol] | 2403 | [symbol] | 2404 | [symbol] | 2405 | [symbol] |
| 2406 | [symbol] | 2407 | [symbol] | 2408 | [symbol] | 2409 | [symbol] | 2410 | [symbol] |
| 2411 | [symbol] | 2412 | [symbol] | 2413 | [symbol] | 2414 | [symbol] | 2415 | [symbol] |
| 2416 | [symbol] | 2417 | [symbol] | 2418 | [symbol] | 2419 | [symbol] | 2420 | [symbol] |
| 2421 | [symbol] | 2422 | [symbol] | 2423 | [symbol] | 2424 | [symbol] | 2425 | [symbol] |
| 2426 | [symbol] | 2427 | [symbol] | 2428 | [symbol] | 2429 | [symbol] | 2430 | [symbol] |
| 2431 | [symbol] | 2432 | [symbol] | 2433 | [symbol] | 2434 | [symbol] | 2435 | [symbol] |
| 2436 | [symbol] | 2437 | [symbol] | 2438 | [symbol] | 2439 | [symbol] | 2440 | [symbol] |
| 2441 | [symbol] | 2442 | [symbol] | 2443 | [symbol] | 2444 | [symbol] | 2445 | [symbol] |
| 2446 | [symbol] | 2447 | [symbol] | 2448 | [symbol] | 2449 | [symbol] | 2450 | [symbol] |
| 2451 | [symbol] | 2452 | [symbol] | 2453 | [symbol] | 2454 | [symbol] | 2455 | [symbol] |
| 2456 | [symbol] | 2457 | [symbol] | 2458 | [symbol] | 2459 | [symbol] | 2460 | [symbol] |
| 2461 | [symbol] | 2462 | [symbol] | 2463 | [symbol] | 2464 | [symbol] | 2465 | [symbol] |
| 2466 | [symbol] | 2467 | [symbol] | 2468 | [symbol] | 2469 | [symbol] | 2470 | [symbol] |
| 2471 | [symbol] | 2472 | [symbol] | 2473 | [symbol] | 2474 | [symbol] | 2475 | [symbol] |
| 2476 | [symbol] | 2477 | [symbol] | 2478 | [symbol] | 2479 | [symbol] | 2480 | [symbol] |
| 2481 | [symbol] | 2482 | [symbol] | 2483 | [symbol] | 2484 | [symbol] | 2485 | [symbol] |
| 2486 | [symbol] | 2487 | [symbol] | 2488 | [symbol] | 2489 | [symbol] | 2490 | [symbol] |
| 2491 | [symbol] | 2492 | [symbol] | 2493 | [symbol] | 2494 | [symbol] | 2495 | [symbol] |
| 2496 | [symbol] | 2497 | [symbol] | | | | | | |

8 STROKES

| | | | | | | | | | |
|---|---|---|---|---|---|---|---|---|---|
| 2601 | [symbol] | 2602 | [symbol] | 2603 | [symbol] | 2604 | [symbol] | 2605 | [symbol] |
| 2606 | [symbol] | 2607 | [symbol] | 2608 | [symbol] | 2609 | [symbol] | 2610 | [symbol] |
| 2611 | [symbol] | 2612 | [symbol] | 2613 | [symbol] | 2614 | [symbol] | 2615 | [symbol] |
| 2616 | [symbol] | 2617 | [symbol] | 2618 | [symbol] | 2619 | [symbol] | 2620 | [symbol] |
| 2621 | [symbol] | 2622 | [symbol] | 2623 | [symbol] | 2624 | [symbol] | 2625 | [symbol] |
| 2626 | [symbol] | 2627 | [symbol] | 2628 | [symbol] | 2629 | [symbol] | 2630 | [symbol] |
| 2631 | [symbol] | 2632 | [symbol] | 2633 | [symbol] | 2634 | [symbol] | 2635 | [symbol] |
| 2636 | [symbol] | 2637 | [symbol] | 2638 | [symbol] | 2639 | [symbol] | 2640 | [symbol] |
| 2641 | [symbol] | 2642 | [symbol] | 2643 | [symbol] | 2644 | [symbol] | 2645 | [symbol] |
| 2646 | [symbol] | 2647 | [symbol] | 2648 | [symbol] | 2649 | [symbol] | 2650 | [symbol] |
| 2651 | [symbol] | 2652 | [symbol] | 2653 | [symbol] | 2654 | [symbol] | 2655 | [symbol] |
| 2656 | [symbol] | 2657 | [symbol] | 2658 | [symbol] | 2659 | [symbol] | 2660 | [symbol] |
| 2661 | [symbol] | 2662 | [symbol] | 2663 | [symbol] | 2664 | [symbol] | 2665 | [symbol] |
| 2666 | [symbol] | 2667 | [symbol] | 2668 | [symbol] | 2669 | [symbol] | 2670 | [symbol] |
| 2671 | [symbol] | 2672 | [symbol] | 2673 | [symbol] | 2674 | [symbol] | 2675 | [symbol] |
| 2676 | [symbol] | 2677 | [symbol] | 2678 | [symbol] | 2679 | [symbol] | 2680 | [symbol] |
| 2681 | [symbol] | 2682 | [symbol] | 2683 | [symbol] | 2684 | [symbol] | 2685 | [symbol] |
| 2686 | [symbol] | 2687 | [symbol] | 2688 | [symbol] | 2689 | [symbol] | 2690 | [symbol] |
| 2691 | [symbol] | 2692 | [symbol] | 2693 | [symbol] | 2694 | [symbol] | 2695 | [symbol] |
| 2696 | [symbol] | 2697 | [symbol] | 2698 | [symbol] | 2699 | [symbol] | 2700 | [symbol] |
| 2701 | [symbol] | 2702 | [symbol] | 2703 | [symbol] | 2704 | [symbol] | 2705 | [symbol] |
| 2706 | [symbol] | 2707 | [symbol] | 2708 | [symbol] | 2709 | [symbol] | 2710 | [symbol] |
| 2711 | [symbol] | 2712 | [symbol] | 2713 | [symbol] | 2714 | [symbol] | 2715 | [symbol] |
| 2716 | [symbol] | 2717 | [symbol] | 2718 | [symbol] | 2719 | [symbol] | 2720 | [symbol] |
| 2721 | [symbol] | 2722 | [symbol] | 2723 | [symbol] | 2724 | [symbol] | 2725 | [symbol] |
| 2726 | [symbol] | 2727 | [symbol] | 2728 | [symbol] | 2729 | [symbol] | 2730 | [symbol] |
| 2731 | [symbol] | 2732 | [symbol] | 2733 | [symbol] | 2734 | [symbol] | | |

9 STROKES

| | | | | | | | | | |
|---|---|---|---|---|---|---|---|---|---|
| 2801 | [symbol] | 2802 | [symbol] | 2803 | [symbol] | 2804 | [symbol] | 2805 | [symbol] |
| 2806 | [symbol] | 2807 | [symbol] | 2808 | [symbol] | 2809 | [symbol] | 2810 | [symbol] |
| 2811 | [symbol] | 2812 | [symbol] | 2813 | [symbol] | 2814 | [symbol] | 2815 | [symbol] |
| 2816 | [symbol] | 2817 | [symbol] | 2818 | [symbol] | 2819 | [symbol] | 2820 | [symbol] |
| 2821 | [symbol] | 2822 | [symbol] | 2823 | [symbol] | 2824 | [symbol] | 2825 | [symbol] |
| 2826 | [symbol] | 2827 | [symbol] | 2828 | [symbol] | 2829 | [symbol] | 2830 | [symbol] |
| 2831 | [symbol] | 2832 | [symbol] | 2833 | [symbol] | 2834 | [symbol] | 2835 | [symbol] |
| 2836 | [symbol] | 2837 | [symbol] | 2838 | [symbol] | 2839 | [symbol] | 2840 | [symbol] |
| 2841 | [symbol] | 2842 | [symbol] | 2843 | [symbol] | 2844 | [symbol] | 2845 | [symbol] |
| 2846 | [symbol] | 2847 | [symbol] | 2848 | [symbol] | 2849 | [symbol] | 2850 | [symbol] |
| 2851 | [symbol] | 2852 | [symbol] | 2853 | [symbol] | 2854 | [symbol] | 2855 | [symbol] |
| 2856 | [symbol] | 2857 | [symbol] | 2858 | [symbol] | 2859 | [symbol] | 2860 | [symbol] |
| 2861 | [symbol] | 2862 | [symbol] | 2863 | [symbol] | 2864 | [symbol] | 2865 | [symbol] |
| 2866 | [symbol] | 2867 | [symbol] | 2868 | [symbol] | 2869 | [symbol] | 2870 | [symbol] |
| 2871 | [symbol] | 2872 | [symbol] | 2873 | [symbol] | 2874 | [symbol] | 2875 | [symbol] |
| 2876 | [symbol] | 2877 | [symbol] | 2878 | [symbol] | 2879 | [symbol] | 2880 | [symbol] |
| 2881 | [symbol] | 2882 | [symbol] | 2883 | [symbol] | 2884 | [symbol] | 2885 | [symbol] |
| 2886 | [symbol] | 2887 | [symbol] | 2888 | [symbol] | 2889 | [symbol] | 2890 | [symbol] |
| 2891 | [symbol] | 2892 | [symbol] | 2893 | [symbol] | 2894 | [symbol] | 2895 | [symbol] |
| 2896 | [symbol] | 2897 | [symbol] | 2898 | [symbol] | 2899 | [symbol] | 2900 | [symbol] |
| 2901 | [symbol] | 2902 | [symbol] | 2903 | [symbol] | 2904 | [symbol] | 2905 | [symbol] |
| 2906 | [symbol] | 2907 | [symbol] | 2908 | [symbol] | 2909 | [symbol] | 2910 | [symbol] |
| 2911 | [symbol] | 2912 | [symbol] | 2913 | [symbol] | 2914 | [symbol] | 2915 | [symbol] |
| 2916 | [symbol] | 2917 | [symbol] | 2918 | [symbol] | 2919 | [symbol] | 2920 | [symbol] |
| 2921 | [symbol] | 2922 | [symbol] | 2923 | [symbol] | 2924 | [symbol] | | |

10 STROKES

| | | | | | | | | | |
|---|---|---|---|---|---|---|---|---|---|
| 3001 | [symbol] | 3002 | [symbol] | 3003 | [symbol] | 3004 | [symbol] | 3005 | [symbol] |
| 3006 | [symbol] | 3007 | [symbol] | 3008 | [symbol] | 3009 | [symbol] | 3010 | [symbol] |
| 3011 | [symbol] | 3012 | [symbol] | 3013 | [symbol] | 3014 | [symbol] | 3015 | [symbol] |
| 3016 | [symbol] | 3017 | [symbol] | 3018 | [symbol] | 3019 | [symbol] | 3020 | [symbol] |
| 3021 | [symbol] | 3022 | [symbol] | 3023 | [symbol] | 3024 | [symbol] | 3025 | [symbol] |
| 3026 | [symbol] | 3027 | [symbol] | 3028 | [symbol] | 3029 | [symbol] | 3030 | [symbol] |
| 3031 | [symbol] | 3032 | [symbol] | 3033 | [symbol] | 3034 | [symbol] | 3035 | [symbol] |
| 3036 | [symbol] | 3037 | [symbol] | 3038 | [symbol] | 3039 | [symbol] | 3040 | [symbol] |
| 3041 | [symbol] | 3042 | [symbol] | 3043 | [symbol] | 3044 | [symbol] | 3045 | [symbol] |
| 3046 | [symbol] | 3047 | [symbol] | 3048 | [symbol] | 3049 | [symbol] | 3050 | [symbol] |
| 3051 | [symbol] | 3052 | [symbol] | 3053 | [symbol] | 3054 | [symbol] | 3055 | [symbol] |
| 3056 | [symbol] | 3057 | [symbol] | 3058 | [symbol] | 3059 | [symbol] | 3060 | [symbol] |
| 3061 | [symbol] | 3062 | [symbol] | 3063 | [symbol] | 3064 | [symbol] | 3065 | [symbol] |
| 3066 | [symbol] | 3067 | [symbol] | 3068 | [symbol] | 3069 | [symbol] | 3070 | [symbol] |
| 3071 | [symbol] | 3072 | [symbol] | 3073 | [symbol] | 3074 | [symbol] | 3075 | [symbol] |
| 3076 | [symbol] | 3077 | [symbol] | 3078 | [symbol] | 3079 | [symbol] | 3080 | [symbol] |
| 3081 | [symbol] | 3082 | [symbol] | 3083 | [symbol] | 3084 | [symbol] | 3085 | [symbol] |
| 3086 | [symbol] | 3087 | [symbol] | 3088 | [symbol] | 3089 | [symbol] | 3090 | [symbol] |
| 3091 | [symbol] | 3092 | [symbol] | 3093 | [symbol] | 3094 | [symbol] | 3095 | [symbol] |
| 3096 | [symbol] | 3097 | [symbol] | 3098 | [symbol] | 3099 | [symbol] | 3100 | [symbol] |
| 3101 | [symbol] | 3102 | [symbol] | 3103 | [symbol] | 3104 | [symbol] | 3105 | [symbol] |
| 3106 | [symbol] | 3107 | [symbol] | 3108 | [symbol] | 3109 | [symbol] | 3110 | [symbol] |
| 3111 | [symbol] | | | | | | | | |

11 STROKES

| | | | | | | | | | |
|---|---|---|---|---|---|---|---|---|---|
| 3201 | [symbol] | 3202 | [symbol] | 3203 | [symbol] | 3204 | [symbol] | 3205 | [symbol] |
| 3206 | [symbol] | 3207 | [symbol] | 3208 | [symbol] | 3209 | [symbol] | 3210 | [symbol] |
| 3211 | [symbol] | 3212 | [symbol] | 3213 | [symbol] | 3214 | [symbol] | 3215 | [symbol] |
| 3216 | [symbol] | 3217 | [symbol] | 3218 | [symbol] | 3219 | [symbol] | 3220 | [symbol] |
| 3221 | [symbol] | 3222 | [symbol] | 3223 | [symbol] | 3224 | [symbol] | 3225 | [symbol] |
| 3226 | [symbol] | 3227 | [symbol] | 3228 | [symbol] | 3229 | [symbol] | 3230 | [symbol] |
| 3231 | [symbol] | 3232 | [symbol] | 3233 | [symbol] | 3234 | [symbol] | 3235 | [symbol] |
| 3236 | [symbol] | 3237 | [symbol] | 3238 | [symbol] | 3239 | [symbol] | 3240 | [symbol] |
| 3241 | [symbol] | 3242 | [symbol] | 3243 | [symbol] | 3244 | [symbol] | 3245 | [symbol] |
| 3246 | [symbol] | 3247 | [symbol] | 3248 | [symbol] | 3249 | [symbol] | 3250 | [symbol] |
| 3251 | [symbol] | 3252 | [symbol] | 3253 | [symbol] | 3254 | [symbol] | 3255 | [symbol] |
| 3256 | [symbol] | 3257 | [symbol] | 3258 | [symbol] | 3259 | [symbol] | 3260 | [symbol] |
| 3261 | [symbol] | 3262 | [symbol] | 3263 | [symbol] | 3264 | [symbol] | 3265 | [symbol] |
| 3266 | [symbol] | 3267 | [symbol] | 3268 | [symbol] | 3269 | [symbol] | 3270 | [symbol] |
| 3271 | [symbol] | 3272 | [symbol] | 3273 | [symbol] | 3274 | [symbol] | 3275 | [symbol] |
| 3276 | [symbol] | 3277 | [symbol] | 3278 | [symbol] | 3279 | [symbol] | 3280 | [symbol] |
| 3281 | [symbol] | 3282 | [symbol] | 3283 | [symbol] | 3284 | [symbol] | 3285 | [symbol] |
| 3286 | [symbol] | 3287 | [symbol] | 3288 | [symbol] | 3289 | [symbol] | 3290 | [symbol] |
| 3291 | [symbol] | 3292 | [symbol] | 3293 | [symbol] | 3294 | [symbol] | 3295 | [symbol] |
| 3296 | [symbol] | 3297 | [symbol] | 3298 | [symbol] | 3299 | [symbol] | 3300 | [symbol] |
| 3301 | [symbol] | 3302 | [symbol] | 3303 | [symbol] | 3304 | [symbol] | 3305 | [symbol] |
| 3306 | [symbol] | 3307 | [symbol] | 3308 | [symbol] | 3309 | [symbol] | 3310 | [symbol] |
| 3311 | [symbol] | 3312 | [symbol] | 3313 | [symbol] | 3314 | [symbol] | 3315 | [symbol] |
| 3316 | [symbol] | | | | | | | | |

12 STROKES

| | | | | | | | | | |
|---|---|---|---|---|---|---|---|---|---|
| 3401 | [symbol] | 3402 | [symbol] | 3403 | [symbol] | 3404 | [symbol] | 3405 | [symbol] |
| 3406 | [symbol] | 3407 | [symbol] | 3408 | [symbol] | 3409 | [symbol] | 3410 | [symbol] |
| 3411 | [symbol] | 3412 | [symbol] | 3413 | [symbol] | 3414 | [symbol] | 3415 | [symbol] |
| 3416 | [symbol] | 3417 | [symbol] | 3418 | [symbol] | 3419 | [symbol] | 3420 | [symbol] |
| 3421 | [symbol] | 3422 | [symbol] | 3423 | [symbol] | 3424 | [symbol] | 3425 | [symbol] |
| 3426 | [symbol] | 3427 | [symbol] | 3428 | [symbol] | 3429 | [symbol] | 3430 | [symbol] |
| 3431 | [symbol] | 3432 | [symbol] | 3433 | [symbol] | 3434 | [symbol] | 3435 | [symbol] |
| 3436 | [symbol] | 3437 | [symbol] | 3438 | [symbol] | 3439 | [symbol] | 3440 | [symbol] |
| 3441 | [symbol] | 3442 | [symbol] | 3443 | [symbol] | 3444 | [symbol] | 3445 | [symbol] |
| 3446 | [symbol] | 3447 | [symbol] | 3448 | [symbol] | 3449 | [symbol] | 3450 | [symbol] |
| 3451 | [symbol] | 3452 | [symbol] | 3453 | [symbol] | 3454 | [symbol] | 3455 | [symbol] |
| 3456 | [symbol] | 3457 | [symbol] | 3458 | [symbol] | 3459 | [symbol] | 3460 | [symbol] |
| 3461 | [symbol] | 3462 | [symbol] | 3463 | [symbol] | 3464 | [symbol] | 3465 | [symbol] |
| 3466 | [symbol] | 3467 | [symbol] | 3468 | [symbol] | 3469 | [symbol] | 3470 | [symbol] |
| 3471 | [symbol] | 3472 | [symbol] | 3473 | [symbol] | 3474 | [symbol] | 3475 | [symbol] |
| 3476 | [symbol] | 3477 | [symbol] | 3478 | [symbol] | 3479 | [symbol] | 3480 | [symbol] |
| 3481 | [symbol] | 3482 | [symbol] | 3483 | [symbol] | 3484 | [symbol] | 3485 | [symbol] |
| 3486 | [symbol] | 3487 | [symbol] | 3488 | [symbol] | 3489 | [symbol] | 3490 | [symbol] |
| 3491 | [symbol] | 3492 | [symbol] | 3493 | [symbol] | 3494 | [symbol] | 3495 | [symbol] |
| 3496 | [symbol] | 3497 | [symbol] | 3498 | [symbol] | 3499 | [symbol] | 3500 | [symbol] |
| 3501 | [symbol] | 3502 | [symbol] | 3503 | [symbol] | 3504 | [symbol] | 3505 | [symbol] |
| 3506 | [symbol] | 3507 | [symbol] | | | | | | |

13 STROKES

| | | | | | | | | | |
|---|---|---|---|---|---|---|---|---|---|
| 3601 | [symbol] | 3602 | [symbol] | 3603 | [symbol] | 3604 | [symbol] | 3605 | [symbol] |
| 3606 | [symbol] | 3607 | [symbol] | 3608 | [symbol] | 3609 | [symbol] | 3610 | [symbol] |
| 3611 | [symbol] | 3612 | [symbol] | 3613 | [symbol] | 3614 | [symbol] | 3615 | [symbol] |
| 3616 | [symbol] | 3617 | [symbol] | 3618 | [symbol] | 3619 | [symbol] | 3620 | [symbol] |
| 3621 | [symbol] | 3622 | [symbol] | 3623 | [symbol] | 3624 | [symbol] | 3625 | [symbol] |
| 3626 | [symbol] | 3627 | [symbol] | 3628 | [symbol] | 3629 | [symbol] | 3630 | [symbol] |
| 3631 | [symbol] | 3632 | [symbol] | 3633 | [symbol] | 3634 | [symbol] | 3635 | [symbol] |
| 3636 | [symbol] | 3637 | [symbol] | 3638 | [symbol] | 3639 | [symbol] | 3640 | [symbol] |
| 3641 | [symbol] | 3642 | [symbol] | 3643 | [symbol] | 3644 | [symbol] | 3645 | [symbol] |
| 3646 | [symbol] | 3647 | [symbol] | 3648 | [symbol] | 3649 | [symbol] | 3650 | [symbol] |
| 3651 | [symbol] | 3652 | [symbol] | 3653 | [symbol] | 3654 | [symbol] | 3655 | [symbol] |
| 3656 | [symbol] | 3657 | [symbol] | 3658 | [symbol] | 3659 | [symbol] | 3660 | [symbol] |
| 3661 | [symbol] | 3662 | [symbol] | 3663 | [symbol] | 3664 | [symbol] | 3665 | [symbol] |
| 3666 | [symbol] | 3667 | [symbol] | 3668 | [symbol] | 3669 | [symbol] | 3670 | [symbol] |
| 3671 | [symbol] | 3672 | [symbol] | 3673 | [symbol] | 3674 | [symbol] | 3675 | [symbol] |

14 STROKES

| | | | | | | | | | |
|---|---|---|---|---|---|---|---|---|---|
| 3801 | [symbol] | 3802 | [symbol] | 3803 | [symbol] | 3804 | [symbol] | 3805 | [symbol] |
| 3806 | [symbol] | 3807 | [symbol] | 3808 | [symbol] | 3809 | [symbol] | 3810 | [symbol] |
| 3811 | [symbol] | 3812 | [symbol] | 3813 | [symbol] | 3814 | [symbol] | 3815 | [symbol] |
| 3816 | [symbol] | 3817 | [symbol] | 3818 | [symbol] | 3819 | [symbol] | 3820 | [symbol] |
| 3821 | [symbol] | 3822 | [symbol] | 3823 | [symbol] | 3824 | [symbol] | 3825 | [symbol] |
| 3826 | [symbol] | 3827 | [symbol] | 3828 | [symbol] | 3829 | [symbol] | 3830 | [symbol] |
| 3831 | [symbol] | 3832 | [symbol] | 3833 | [symbol] | 3834 | [symbol] | 3835 | [symbol] |
| 3836 | [symbol] | 3837 | [symbol] | 3838 | [symbol] | | | | |

15 STROKES

| | | | | | | | | | |
|---|---|---|---|---|---|---|---|---|---|
| 4001 | [symbol] | 4002 | [symbol] | 4003 | [symbol] | 4004 | [symbol] | 4005 | [symbol] |
| 4006 | [symbol] | 4007 | [symbol] | 4008 | [symbol] | 4009 | [symbol] | 4010 | [symbol] |
| 4011 | [symbol] | 4012 | [symbol] | 4013 | [symbol] | 4014 | [symbol] | 4015 | [symbol] |
| 4016 | [symbol] | 4017 | [symbol] | 4018 | [symbol] | 4019 | [symbol] | 4020 | [symbol] |
| 4021 | [symbol] | 4022 | [symbol] | 4023 | [symbol] | 4024 | [symbol] | 4025 | [symbol] |
| 4026 | [symbol] | 4027 | [symbol] | 4028 | [symbol] | 4029 | [symbol] | 4030 | [symbol] |
| 4031 | [symbol] | 4032 | [symbol] | 4033 | [symbol] | 4034 | [symbol] | 4035 | [symbol] |

16 STROKES

| | | | | | | | | | |
|---|---|---|---|---|---|---|---|---|---|
| 4201 | [symbol] | 4202 | [symbol] | 4203 | [symbol] | 4204 | [symbol] | 4205 | [symbol] |
| 4206 | [symbol] | 4207 | [symbol] | 4208 | [symbol] | 4209 | [symbol] | 4210 | [symbol] |
| 4211 | [symbol] | 4212 | [symbol] | 4213 | [symbol] | 4214 | [symbol] | 4215 | [symbol] |
| 4216 | [symbol] | 4217 | [symbol] | 4218 | [symbol] | 4219 | [symbol] | 4220 | [symbol] |
| 4221 | [symbol] | 4222 | [symbol] | 4223 | [symbol] | 4224 | [symbol] | 4225 | [symbol] |
| 4226 | [symbol] | | | | | | | | |

17 STROKES

| | | | | | | | | | |
|---|---|---|---|---|---|---|---|---|---|
| 4401 | [symbol] | 4402 | [symbol] | 4403 | [symbol] | 4404 | [symbol] | 4405 | [symbol] |
| 4406 | [symbol] | 4407 | [symbol] | 4408 | [symbol] | 4409 | [symbol] | 4410 | [symbol] |
| 4411 | [symbol] | 4412 | [symbol] | 4413 | [symbol] | 4414 | [symbol] | 4415 | [symbol] |
| 4416 | [symbol] | 4417 | [symbol] | 4418 | [symbol] | 4419 | [symbol] | | |

18 STROKES

| | | | | | | | | | |
|---|---|---|---|---|---|---|---|---|---|
| 4601 | [symbol] | 4602 | [symbol] | 4603 | [symbol] | 4604 | [symbol] | 4605 | [symbol] |
| 4606 | [symbol] | 4607 | [symbol] | 4608 | [symbol] | 4609 | [symbol] | 4610 | [symbol] |

19 STROKES

| | | | | | | | | | |
|---|---|---|---|---|---|---|---|---|---|
| 4801 | [symbol] | 4802 | [symbol] | 4803 | [symbol] | 4804 | [symbol] | 4805 | [symbol] |
| 4806 | [symbol] | 4807 | [symbol] | 4808 | [symbol] | 4809 | [symbol] | 4810 | [symbol] |
| 4811 | [symbol] | 4812 | [symbol] | 4813 | [symbol] | | | | |

20 STROKES

| | | | | | | | | | |
|---|---|---|---|---|---|---|---|---|---|
| 5001 | [symbol] | 5002 | [symbol] | 5003 | [symbol] | 5004 | [symbol] | 5005 | [symbol] |
| 5006 | [symbol] | 5007 | [symbol] | 5008 | [symbol] | 5009 | [symbol] | | |

21 STROKES

| | | | | | | | |
|---|---|---|---|---|---|---|---|
| 5201 | [symbol] | 5202 | [symbol] | 5203 | [symbol] | 5204 | [symbol] |

22 STROKES

| | | | |
|---|---|---|---|
| 5401 | [symbol] | 5402 | [symbol] |

24 STROKES

| | | | |
|---|---|---|---|
| 5801 | [symbol] | 5802 | [symbol] |

25 STROKES

| | | | | | |
|---|---|---|---|---|---|
| 6001 | [symbol] | 6002 | [symbol] | 6003 | [symbol] |

29 STROKES

| | | | |
|---|---|---|---|
| 6801 | [symbol] | 6802 | [symbol] |

TABLE 5
1 STROKE

| | | | | | | | | | |
|---|---|---|---|---|---|---|---|---|---|
| 0001 | [symbol] | 0002 | [symbol] | 0003 | [symbol] | 0004 | [symbol] | 0005 | [symbol] |
| 0006 | [symbol] | | | | | | | | |

2 STROKES

| | | | | | | | | | |
|---|---|---|---|---|---|---|---|---|---|
| 0007 | [symbol] | 0008 | [symbol] | 0009 | [symbol] | 0010 | [symbol] | 0011 | [symbol] |
| 0012 | [symbol] | 0013 | [symbol] | 0014 | [symbol] | 0015 | [symbol] | 0016 | [symbol] |
| 0017 | [symbol] | 0018 | [symbol] | 0019 | [symbol] | 0020 | [symbol] | 0021 | [symbol] |
| 0022 | [symbol] | 0023 | [symbol] | 0024 | [symbol] | 0025 | [symbol] | 0026 | [symbol] |
| 0027 | [symbol] | 0028 | [symbol] | 0029 | [symbol] | | | | |

3 STROKES

| | | | | | | | | | |
|---|---|---|---|---|---|---|---|---|---|
| 0030 | [symbol] | 0031 | [symbol] | 0032 | [symbol] | 0033 | [symbol] | 0034 | [symbol] |
| 0035 | [symbol] | 0036 | [symbol] | 0037 | [symbol] | 0038 | [symbol] | 0039 | [symbol] |
| 0040 | [symbol] | 0041 | [symbol] | 0042 | [symbol] | 0043 | [symbol] | 0044 | [symbol] |
| 0045 | [symbol] | 0046 | [symbol] | 0047 | [symbol] | 0048 | [symbol] | 0049 | [symbol] |
| 0050 | [symbol] | 0051 | [symbol] | 0052 | [symbol] | 0053 | [symbol] | 0054 | [symbol] |
| 0055 | [symbol] | 0056 | [symbol] | 0057 | [symbol] | 0058 | [symbol] | 0059 | [symbol] |
| 0060 | [symbol] | | | | | | | | |

4 STROKES

| | | | | | | | | | |
|---|---|---|---|---|---|---|---|---|---|
| 0061 | [symbol] | 0062 | [symbol] | 0063 | [symbol] | 0064 | [symbol] | 0065 | [symbol] |
| 0066 | [symbol] | 0067 | [symbol] | 0068 | [symbol] | 0069 | [symbol] | 0070 | [symbol] |
| 0071 | [symbol] | 0072 | [symbol] | 0073 | [symbol] | 0074 | [symbol] | 0075 | [symbol] |
| 0076 | [symbol] | 0077 | [symbol] | 0078 | [symbol] | 0079 | [symbol] | 0080 | [symbol] |
| 0081 | [symbol] | 0082 | [symbol] | 0083 | [symbol] | 0084 | [symbol] | 0085 | [symbol] |
| 0086 | [symbol] | 0087 | [symbol] | 0088 | [symbol] | 0089 | [symbol] | 0090 | [symbol] |
| 0091 | [symbol] | 0092 | [symbol] | 0093 | [symbol] | 0094 | [symbol] | | |

5 STROKES

| | | | | | | | | | |
|---|---|---|---|---|---|---|---|---|---|
| 0095 | [symbol] | 0096 | [symbol] | 0097 | [symbol] | 0098 | [symbol] | 0099 | [symbol] |
| 0100 | [symbol] | 0101 | [symbol] | 0102 | [symbol] | 0103 | [symbol] | 0104 | [symbol] |
| 0105 | [symbol] | 0106 | [symbol] | 0107 | [symbol] | 0108 | [symbol] | 0109 | [symbol] |
| 0110 | [symbol] | 0111 | [symbol] | 0112 | [symbol] | 0113 | [symbol] | 0114 | [symbol] |
| 0115 | [symbol] | 0116 | [symbol] | 0117 | [symbol] | | | | |

6 STROKES

| | | | | | | | | | |
|---|---|---|---|---|---|---|---|---|---|
| 0118 | [symbol] | 0119 | [symbol] | 0120 | [symbol] | 0121 | [symbol] | 0122 | [symbol] |
| 0123 | [symbol] | 0124 | [symbol] | 0125 | [symbol] | 0126 | [symbol] | 0127 | [symbol] |
| 0128 | [symbol] | 0129 | [symbol] | 0130 | [symbol] | 0131 | [symbol] | 0132 | [symbol] |
| 0133 | [symbol] | 0134 | [symbol] | 0135 | [symbol] | 0136 | [symbol] | 0137 | [symbol] |
| 0138 | [symbol] | 0139 | [symbol] | 0140 | [symbol] | 0141 | [symbol] | 0142 | [symbol] |
| 0143 | [symbol] | 0144 | [symbol] | 0145 | [symbol] | 0146 | [symbol] | | |

7 STROKES

| | | | | | | | | | |
|---|---|---|---|---|---|---|---|---|---|
| 0147 | [symbol] | 0148 | [symbol] | 0149 | [symbol] | 0150 | [symbol] | 0151 | [symbol] |
| 0152 | [symbol] | 0153 | [symbol] | 0154 | [symbol] | 0155 | [symbol] | 0156 | [symbol] |
| 0157 | [symbol] | 0158 | [symbol] | 0159 | [symbol] | 0160 | [symbol] | 0161 | [symbol] |
| 0162 | [symbol] | 0163 | [symbol] | 0164 | [symbol] | 0165 | [symbol] | 0166 | [symbol] |

8 STROKES

| | | | | | | | | | |
|---|---|---|---|---|---|---|---|---|---|
| 0167 | [symbol] | 0168 | [symbol] | 0169 | [symbol] | 0170 | [symbol] | 0171 | [symbol] |
| 0172 | [symbol] | 0173 | [symbol] | 0174 | [symbol] | 0175 | [symbol] | | |

9 STROKES

| | | | | | | | | | |
|---|---|---|---|---|---|---|---|---|---|
| 0176 | [symbol] | 0177 | [symbol] | 0178 | [symbol] | 0179 | [symbol] | 0180 | [symbol] |
| 0181 | [symbol] | 0182 | [symbol] | 0183 | [symbol] | 0184 | [symbol] | 0185 | [symbol] |
| 0186 | [symbol] | | | | | | | | |

10 STROKES

| | | | | | | | | | |
|---|---|---|---|---|---|---|---|---|---|
| 0187 | [symbol] | 0188 | [symbol] | 0189 | [symbol] | 0190 | [symbol] | 0191 | [symbol] |
| 0192 | [symbol] | 0193 | [symbol] | 0194 | [symbol] | | | | |

11 STROKES

| | | | | | | | | | |
|---|---|---|---|---|---|---|---|---|---|
| 0195 | [symbol] | 0196 | [symbol] | 0197 | [symbol] | 0198 | [symbol] | 0199 | [symbol] |
| 0200 | [symbol] | | | | | | | | |

12 STROKES

| | | | | | | | |
|---|---|---|---|---|---|---|---|
| 0201 | [symbol] | 0202 | [symbol] | 0203 | [symbol] | 0204 | [symbol] |

13 STROKES

| | | | | | | | |
|---|---|---|---|---|---|---|---|
| 0205 | [symbol] | 0206 | [symbol] | 0207 | [symbol] | 0208 | [symbol] |

14 STROKES

| | | | |
|---|---|---|---|
| 0209 | [symbol] | 0210 | [symbol] |

15 STROKES

| | |
|---|---|
| 0211 | [symbol] |

16 STROKES

| | | | |
|---|---|---|---|
| 0212 | [symbol] | 0213 | [symbol] |

17 STROKES

| | |
|---|---|
| 0214 | [symbol] |

What is claimed is:

1. A method of encoding a Chinese type character, the method comprising the following steps:
(a) Subdividing the said character into N elements in a given order, said order being specific to said character;
(b) Associating with each of the N elements, in said given order, an elementary descriptor, each of these elementary descriptors being based on the structure of said element with which it is associated;
(c) Defining a base reference constituted by the elementary descriptors defined at step (b), these elementary descriptors being placed in said given order.

2. The method according to claim 1, wherein the following steps are implemented before step (a):
checking whether said character is orthodox, and if said character is not orthodox, replacing said character with an orthodox form of said character.

3. The method according to claim 2, wherein said given order is the order in which the strokes constituting said character are drawn;

4. The method according to claim 2, wherein the number N is equal to 4.

5. The method according to claim 2, wherein each of the said elements which contains a stroke is constituted by an elementary block, possibly repeated inside said element, said elementary block being chosen in a finite list of characters.

6. The method according to claim 4, wherein each of the said elements which contains a stroke is constituted by an elementary block, possibly repeated inside said element, said elementary block being chosen in a finite list of characters.

7. The method according to claim 6, wherein, for each of said elements, said elementary descriptor associated with this element is constituted by a repetition index which is representative of the number of times said elementary block appears in said element, and by a base component which is associated with said elementary block, and which is based on the structure of said elementary block.

8. The method according to claim 7, wherein said elementary block belongs to the set of characters listed in Table 4 and Table 5.

9. The method according to claim 8, wherein each of said elementary descriptor is a string of alphanumeric characters.

10. A method of classifying a set of at least a Chinese type character, comprising the following steps:
(a) Checking whether said at least character of the set is orthodox;
(b) If said at least character is not orthodox, replacing said at least character with an orthodox form of said character;
(c) Subdividing this orthodox form of said at least character into 4 elements in the order in which the strokes constituting the orthodox form of said at least character are drawn, each of the said elements which contains a stroke being constituted by an elementary block, possibly repeated inside said element, said elementary block being chosen in a finite list of characters;
(d) Associating with each of these 4 elements, in said order, an elementary descriptor, each of these elementary descriptors being constituted by a repetition index which is representative of the number of times said elementary block appears in said element, and by a base component which is associated with said elementary block, and which is based on the structure of said elementary block;
(e) Defining a base reference constituted by the elementary descriptors defined at step (d), these elementary descriptors being placed in said order;
(f) Repeating steps (b) to (e) for each other orthodox form of said at least character in case said at least character has more than one orthodox form;

11. The method according to claim 10, wherein said set has more than one Chinese type character, and wherein the further following steps are implemented:
(g) Repeating steps (a) to (f) for each character in said set;
(h) For each orthodox character of said set, grouping together all the characters of said set having the same base reference as said orthodox character, thereby defining the family of said orthodox character;
(i) For each family defined in step (h), assigning to each character of said family an indicator which distinguishes this character from other characters of the same family;
(j) Assigning to said character a structural reference, constituted by said indicator and said base reference.

12. The method according to claim 11, wherein said indicator is constituted of:
a form indicator chosen among a group of form indicators, said form indicator indicating the form of the character;
a hierarchy indicator which is used to differentiate from each other characters with the same base reference and form indicator; and
a regional indicator chosen among a group of regional indicators, said regional indicator depending on the geographical origin of said character.

13. The method according to claim 12, wherein said form indicator indicates whether said character is an orthodox character, a variant form of an orthodox character, an erroneous form of a character, a classical form of a character, a simplified form of a character, an alternative form of a character, a prohibited form of a character, a radical form of a character, or a strokes form of a character.

14. The method according to claim 13, wherein said regional indicator is different whether said character is originating from mainland China, Japan, South Korea, Vietnam, Taiwan, Hong-Kong, Macao, North Korea, Singapore, Malaysia.

15. The method according to claim 11, wherein said elementary block belongs to the set of characters listed in Table 4 and Table 5.

16. The method according to claim 12, wherein after step (j), a unique main structural reference is assigned to each character of said set as follows:
If a character has only one structural reference, then its main structural reference is this structural reference, or
If a character has several structural references, one of which being an orthodox form, then the main structural reference is this orthodox form, or
If a character has several structural references, none of which being an orthodox form, then the main structural reference is the structural reference with the smallest hierarchy indicator, and if two or more of these structural references have the smallest hierarchy indicator, then the main structural reference is the one among these two or more structural references which has the smallest non-zero base component.
